(19) United States
(12) Patent Application Publication
(10) Pub. No.: US 2014/0006919 A1
(43) Pub. Date: Jan. 2, 2014

(54) METHOD AND APPARATUS FOR ANNOTATION CONTENT CONVERSIONS

(71) Applicant: Xiaopeng He, North Potomac, MD (US)

(72) Inventor: Xiaopeng He, North Potomac, MD (US)

(73) Assignee: 3S INTERNATIONAL, LLC., North Potomac, MD (US)

(21) Appl. No.: 13/591,396

(22) Filed: Aug. 22, 2012

Related U.S. Application Data
(60) Provisional application No. 61/666,007, filed on Jun. 29, 2012.

(51) Int. Cl. G06F 17/00

(52) U.S. Cl. 715/230

(57) ABSTRACT

Method and apparatus for converting annotation contents from one format to another are provided. The embodiments of this invention prevent annotation data loss when a content viewer generating annotation contents is switched to or replaced by another content viewer, or multiple types of content viewers are in use in a content management system.

### CROSS REFERENCE TO RELATED APPLICATION

This application claims the priority to currently pending U.S. Provisional Patent Application Ser. No. 61/666,007 filed on Jun. 29, 2012 titled “METHOD AND APPARATUS FOR ANNOTATION CONTENT CONVERSIONS”.

### FIELD OF THE INVENTION

This invention relates to the field of computer technology. More specifically, the invention relates to methods and apparatus for converting structured annotation contents from one format to anther in order to prevent annotation data loss and enhance the transparency of annotation data to different components of a content management system.

### BACKGROUND OF THE INVENTION

Content management systems are widely utilized to manage the ever increasing volume of digital data assets of organizations. Digital data assets can be categorized into 2 different categories: structured and unstructured. Although there is no strict line separating the two, structured data normally can be processed by computers while unstructured data normally requires direct human interactions. Typical examples of structured data are information stored in relational database tables. Typical examples of unstructured data are digital documents such as PDF documents, Microsoft Office documents, digital pictures, scanned images, AutoCAD drawings, video and voice recording etc. Typically, human intelligence is required process, utilize and comprehend the content of unstructured digital data. Content management systems use special software applications called content viewers to provide the interface between humans and the unstructured data, allowing human users to carry out activities including, but not limited to, displaying (or playing in the case of an audio or audiovisual document), viewing, processing, printing, annotating, play and collaborating on the documents.

There are many content viewers available. Some content viewers are created to handle documents in a specific format, such as Adobe Acrobat and Adobe Reader. Some content viewers are created to display various formats of documents, such as commercially available content viewers from IGC, Daeja and Snowbound. Some of the content viewers are standalone applications, while others are browser plug-ins built on top of various browser plug-in technologies. Some content viewers rely on servers to render the documents for display, while others render the documents in their native formats within the viewer itself.

Modern content viewers come with a lot more features than simply displaying the documents. Annotation is one of the most important features that many industry leading content viewers provide. This is because annotations provide extra information visually on top of the document content displayed in a content viewer, thus allowing end users to comment and collaborate with other users using annotations. Annotations are also referred to as markups. The action to put annotations on top of a document displayed in a content viewer is commonly referred to as annotating or marking up. There are many types of annotation marks that can be applied to a document, including, but not limited to, lines, arrows, different shapes (rectangles, circles, ovals, polygons etc), polylines, freehand drawings, text, sticky notes, rubber stamps, redactions etc. They provide different ways to annotate or mark up documents. Annotation marks may look as though they are part of the document content when displayed within a content viewer, although annotation contents are normally stored separately from the documents that they are applied to.

Each separate annotation applied to a document is commonly referred to as an annotation object. Each annotation object defines a few user interface attributes such as position, size, shape, color, transparency, orientation, font and the text if the annotation is textual. Each annotation object also defines some attributes that are not explicitly user interface related, for instance page index to indicate on which page of the document the annotation object has been applied. Some annotation objects carry information such as the name of the user who created the annotation object, and the date/time the annotation object was created. Certain of this information helps the document custodian manage the security of the annotation objects. Annotations are overlaid on top of the document. They can be seen as part of the document content displayed from within a content viewer.

Although annotation data is normally persisted as separate content from the document content in a content management repository, annotation objects are not standalone objects. Annotation data is meaningless without the context of the document content that they are applied to.

Due to lack of international standards, the formats of annotation contents are proprietary to the content viewers used to generate the annotation contents. Each content viewer has its own native format for annotation contents to be displayed in the viewer. Some annotation contents are pure text, some are XML based, and some are even binary. Although most industry leading content viewers support some common annotation types such as lines, arrows, rectangles, oval, freehand, text etc, the definitions of these common types are often different from one annotation format to another. Some formats may support a few annotation types that other formats do not support. Additionally, different annotation formats may have different units, schemes and specifications for annotation attributes such as page index, annotation object index, date & time, line width, color, font size, coordinates, binary data encoding schemes, text encoding schemes etc. Annotation contents created from one viewer are often not compatible with annotation contents from another viewer. This situation creates serious issues when an organization decides to switch from one content viewer to another, or uses more than one type of content viewer simultaneously across a content management system. Annotation contents generated from one content viewer are usually not visible from another content viewer. From the end user's perspective this is a data loss scenario. Today, annotation data loss is one of the top concerns for organizations when they consider switching content viewers.

This invention provides a systematic approach to the annotation data loss issue described above. Methods and apparatus for annotation content conversions are revealed in order to prevent annotation data loss to the level of physically possible with various levels of implementation efforts across a content management system. This invention also brings the transparency into annotation contents among different components of a content management system.

### SUMMARY OF THE INVENTION

One embodiment of this invention provides a method for annotation content conversions. With the introduction of an intermediary annotation format, comprising an interface for converting an annotation originally applied in any of a variety of annotation formats to a standard intermediary annotation format, and an interface for converting annotations persisted in the standard intermediary format to any of several target formats, the implementation of annotation content conversions from annotation content of the source format to the annotation content of the target format can be modularized, and the annotation content conversions become by-directional. One advantage of this approach is that it results in significant reduction of redundant code when conversions are required among more than two annotation formats.

Another embodiment of this invention provides a method for storing annotation content in a content management repository. An annotation storage format and on demand annotation conversion apparatus unifies the annotation contents generated from different content viewer. This makes searching annotation contents easier to implement for a content management system, by enhancing the transparency of annotation contents which would otherwise have been a black box to other components of a content management system.

Another embodiment of the invention provides an apparatus for converting all annotation contents in an annotation content repository created by content viewer A to corresponding annotation contents in the format native to content viewer B, so that after content viewer A is replaced by viewer B in the content management system, legacy annotation contents are still retained and displayable from within content viewer B. Annotation contents conversion is performed directly against the annotation content repository in the fashion of batch processing without the requirement of the presence of both content viewers. The conversion process creates new annotation contents in the content management repository, and relationships between annotation contents and the associated document contents are retained during the process of the conversion.

Another embodiment of the invention provides an apparatus for converting annotation contents on demand as requested by the client specifically but not limited to the content viewer. This embodiment can be integrated into application servers, content servers, or annotation servers, from where annotation contents are delivered to the requesting clients. This embodiment can also be integrated into a client side component including but not limited to content viewer plug-ins, and image rendering servers where annotation contents are rendered on top of the document content. This embodiment is able to handle differences between the annotation format native to content viewers and the formats of annotations stored in the annotation content repository.

### BRIEF DESCRIPTION OF THE DRAWINGS

It is to be noted that the appended drawings illustrate only the typical embodiments of this invention and are therefore not to be considered limiting of its scope, for the invention may admit to other equally effective embodiments.

FIG. 1 illustrates one embodiment of this invention with the annotation conversion tool deployed and connected directly to the annotation content repository of a content management system. The annotation conversion tool, after execution, converts all annotation contents of a specified format stored in the annotation repository of a content management system to corresponding annotation contents of another specified format in the fashion of batch processing.

FIG. 2A illustrates another embodiment of this invention being used in a content management system where an application server, or a content server, or both are responsible for processing annotation content requests initiated from the client side and delivering the requested annotation contents to the requesting clients. With the implementation and integration of the annotation conversion library, requested annotation contents get converted from the format stored in the annotation content repository to the format that the clients request in the fashion of on-demand processing.

FIG. 2B illustrates another embodiment of this invention being used in a content management system where a dedicated annotation server is responsible for processing annotation content request from the client side and delivering the requested annotation contents to the requesting clients. With the implementation and integration of the annotation conversion library, requested annotation contents get converted from the format stored in the annotation content repository to the format that the clients request in the fashion of on-demand processing.

FIG. 2C illustrates another embodiment of this invention being used in a content management system where annotation contents of a unified storage format are stored in the annotation content repository and an application server, or a content server or both are responsible for handling and delivering annotation content requests initiated from content viewers. With the implementation and integration of the annotation conversion library, requested annotation contents get converted from the storage format to the format that the content viewers requests before delivering them to the content viewers for display. Also annotation contents generated from within the content viewers are converted from the format native to the content viewer to the storage format before the annotation contents are saved into the annotation content repository.

FIG. 3 illustrates another embodiment of this invention being used in a content management system where the client side specifically but not limited to content viewers making annotation content requests from the server side which delivers annotation contents of unspecified format. With,the implementation and integration of the annotation conversion library, annotation contents delivered from the server side get detected on the fly and converted to the native format that the content viewer is able to recognize and display.

FIG. 4A shows multiple annotation contents are stored in the annotation content repository of a content management system. Single annotation content may contain one or more annotation objects.

FIG. 4B shows an annotation object having many attributes.

FIG. 5 illustrates annotation object conversion process comprised of many sub-conversions of the values of annotation attributes with different unit systems, schemes and specifications between two different annotation content formats.

FIG. 6 is a flowchart illustrating the batch processing of annotation content conversions of annotation contents in a content management repository.

FIG. 7 is a flowchart illustrating the conversion of single annotation content from format A to format B in accordance with one embodiment of the present invention.

FIG. 8 is a flowchart illustrating the conversion of annotation content by dynamically detecting the input format in accordance with one embodiment of the present invention.

FIG. 9A illustrates direct annotation content conversion from format A to format B.

FIG. 9B illustrates the two-step conversion method for by-directional and modularized annotation content conversion among multiple annotation formats.

FIG. 10 illustrates a sample high level implementation of annotation content from format A to format B.

### DETAILED DESCRIPTION OF THE INVENTION

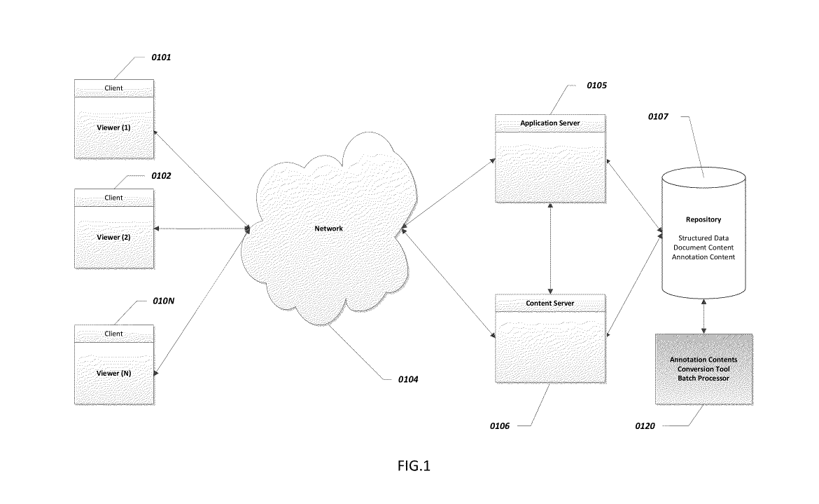

FIG. 1 illustrates an exemplary content management system in which an annotation content conversion tool 0120 implemented in accordance with one embodiment of this invention is operating directly against the annotation content repository 0107 at the server side. The content management system is an electronically networked system. It has a content repository 0107 at the backend for the storage of both structured data and unstructured data such as documents and annotation contents. It has at least one content server 0106 responsible for delivering data stored in the repository 0107 to the requesting clients. It also has at least one application server 0105 to frontend the clients for tasks such as client initialization, authentication, session management, load balancing, data delivery etc. Depending on implementations and configurations, application server 0105 might be required to retrieve annotation contents from the annotation content repository 0107 and deliver the contents to the requesting clients. It might also be responsible for receiving annotation contents uploaded from the clients and saving them into the annotation content repository. The content management system also has multiple content viewers, depicted in FIG. 1 as Viewer (1) 0101, Viewer (2) 0102 and Viewer (N) 010N, connected to the network 0104. Content viewers are used at the client side to display various digital documents and the associated annotations. Depending on the actual implementation and configuration, content viewers may request data directly from the content server 0106 or from the application server 0105. The application server 0105 may retrieve data from the content server 0106 or from the repository 0107. Content server 0106 includes the data delivery servers deployed at the organization headquarters, data centers, or those deployed at branch offices. Content viewers 0101, 0102 and 010N can be any type or from any content viewer vendors. The content viewers can be built from standard plug-in technologies such as ActiveX control, Java Applet or other browser plug-in software systems. Or they can be simply web browser based thin clients built on standard HTML and JavaScript without the usage of any plug-in technology. Thin client content viewer technology relies on separate rendering servers to render document images for display within the viewer.

The annotation contents conversion tool 0120 converts all annotation contents 0401 created by one type of content viewer to the corresponding annotation contents 0401 native to another type of content viewer so that when all the content viewers on the network 0104 are replaced from one type to another type, end users can still see annotation objects created from the replaced content viewers from within the replacing content viewers. The annotation contents conversion tool 0120 functions in the fashion of batch-processing, meaning that it converts annotation contents all at once from one annotation format to another. It also retains the relationship between the annotation content and the associated document that the annotation content is applied to. It is optional at the execution of the annotation contents conversion tool 0120 to either keep the old annotation contents 0901 or delete them from the annotation content repository 0107. If the old annotation contents 0901 are kept in the annotation content repository 0107, both types of content viewers can co-exist in the content management system without losing annotation content data. The annotation content conversion tool 0120 supports multiple annotation formats and converts annotation content among them. If annotation format A, B and C are supported by the tool, then there are conversion executables to convert annotation contents from A to B, A to C, B to C, C to B, C to A, B to A respectively. The benefit of the usage of the annotation contents conversion tool 0120 is that no modifications are required on any of the software/hardware components of the content management system when content viewers are switched from that supporting annotation format A to that supporting annotation format B. Simply executing the annotation contents conversion tool 0120 and allowing it to run to completion of the process will result in all annotation contents created by one type of content viewer being converted to annotation content formats native to each of the other types of supported content viewers. Launching one content viewer to display a document should display all annotation objects 0410 created from any of the other supported content viewers.

FIG. 1 shows the annotation contents conversion tool 0102 directly connected to the annotation content repository 0107. This is just one way of deployment of the annotation contents conversion tool 0102. Annotation contents conversion tool 0102 can be deployed anywhere on the network as long as it has access to the annotation content repository 0107 across the network 0104. The execution of annotation contents conversion tool 0102 does not require the presence of any content viewers.

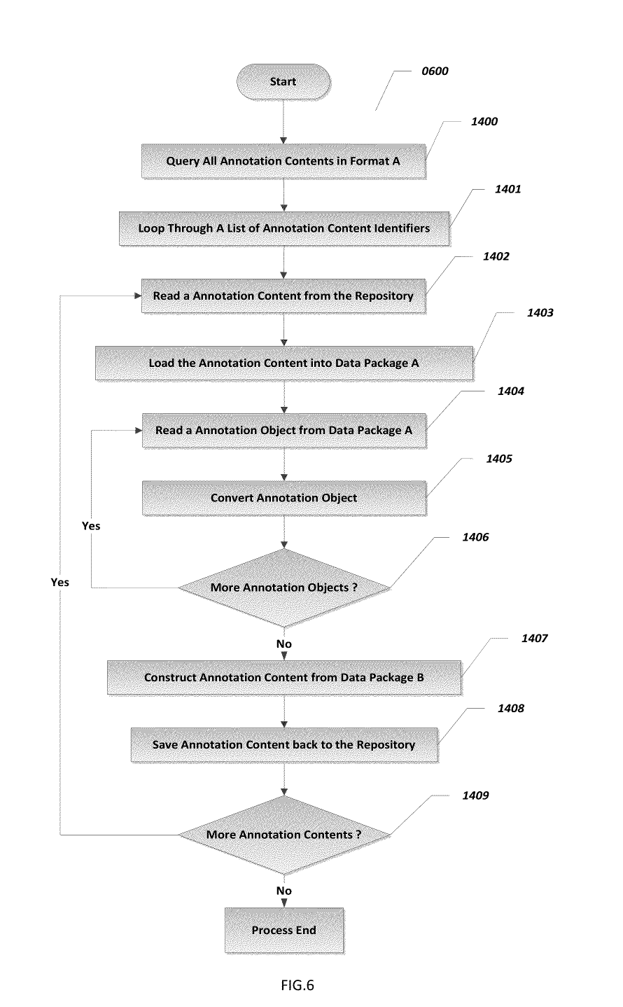

FIG. 6 is a flowchart illustrating the execution sequence of the annotation contents conversion tool 0120. The execution starts from step 1400 which queries the annotation content repository 0107 for a list of identifiers of annotation contents of format A. The returned list of identifiers is passed to a loop illustrated as step 1401 which traverses through all annotation content identifiers of format A for the next operations. With each annotation content identifier, step 1402 reads the annotation content 0901 identified by the annotation content identifier from the annotation content repository 0107. The annotation content 0901 retrieved from the data layer might be a data stream, a file, a string, a byte array, a predefined data structure, an instance of a property class, a file name pointing to a file that contains the annotation content, or an unique identifier that identifies the annotation content. The annotation content 0901 is then pass on to step 1403 which parses the annotation content 0901 from its raw format and then create an annotation data package that is designated to contain the structured data in annotation content 0901 of format A for random access in memory. This step is carried out using a technique generally known in the relevant prior art as deserialization or unmarshalling which converts a stream of structured data into an instance of a property class. Deserialization or unmarshalling transforms data to an object from the data transfer format including but not limited to stream, file, string, byte array etc. This step is optional, only required if annotation content 0901 retrieved from the annotation content repository 0107 is not already a randomly accessible object. If annotation content 0901 retrieved from the annotation repository 0107 is a randomly accessible object in memory, this step can be skipped. The annotation data package is then passed on to the next step which is an inner loop that traverses through all annotation objects contained in the annotation content 0901. The inner loop starts with step 1404 which read an annotation object 0410 from Data Package A. This step returns an annotation object 0410 that contains the values for all annotation attributes. Next, the annotation object 0410 is passed to annotation object conversion routine illustrated by step 1405 which converts annotation object 0410 from that defined in format A to that defined in format B. The converted annotation object 0410 is then added to the collection of annotation objects in data package for annotation content 0902 of format B. At this point, the process checks whether there are more annotation objects from Data Package A that are not going through the conversion, as shown by step 1406. If the answer is yes, the process goes back to step 1404 to read the next annotation object from Data Package A. If the answer is no, the process exits the loop and finalize the construction of annotation content 0902 of format B as shown by step 1407. The construction of annotation content 0902 may optionally involve a technique known as serialization or marshalling which is the opposite operation of deserialization or unmarshalling. It transforms an object into a data transfer format including but not limited to stream, file, string or byte array etc. This step makes sure annotation content 0902 is in the proper form to be saved in the annotation content repository 0107. The next step is 1408 which saves back the annotation content 0902 of format B as a new record in the annotation content repository 0107. At this point, one annotation content 0901 of format A is completely converted into annotation content 0902 of format B, and the new annotation content is readily accessible from a content viewer that supports annotation content 0902 of format B. The next step 1409 checks whether there are more annotation contents 0901 of format A yet to be converted. If the answer is yes, the process goes back to step 1402 to read the next annotation content 0901 of format A from the annotation content repository 0107. If the answer is no, the entire process ends, and all annotation contents of format A are finished converting to corresponding annotation content of format B.

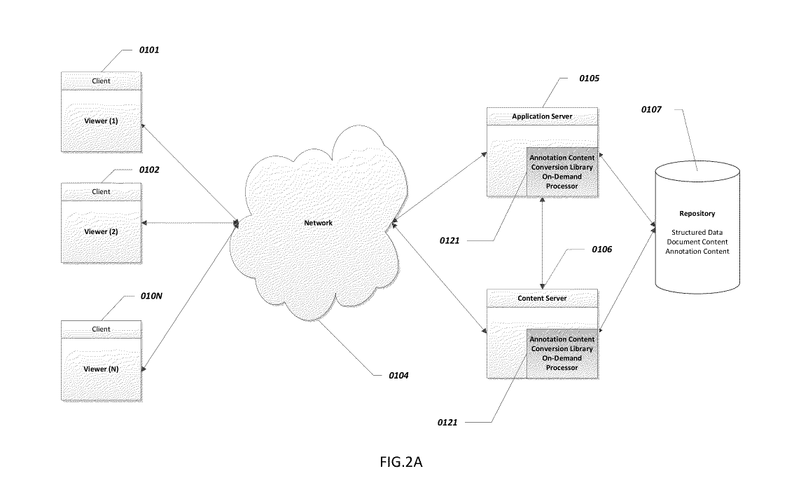

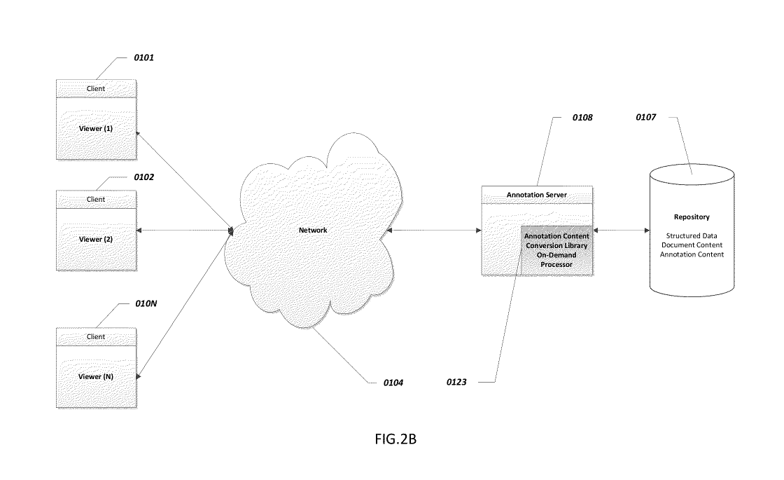

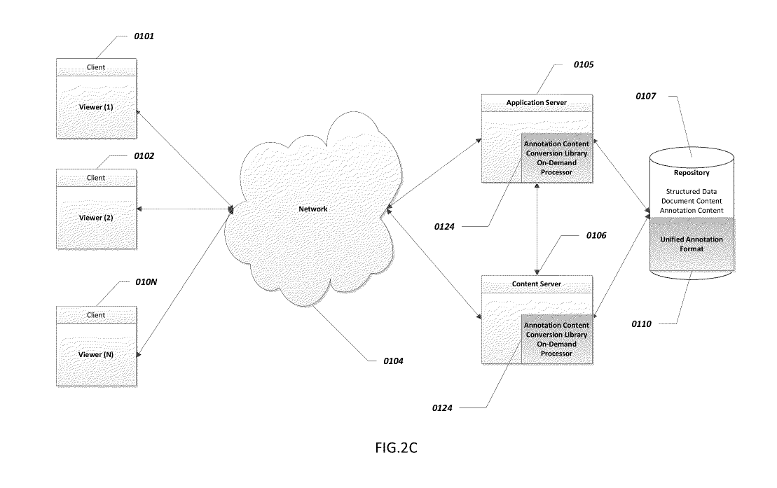

FIG. 2A illustrates the same exemplary content management system as described in FIG. 1 where annotation content conversion library 0121 is implemented in accordance with one embodiment of this invention is integrated into the application server 0105 and the content server 0106. Annotation content conversion library 0121 operates in the fashion of on-demand processing. It converts annotation contents on the fly from format A to format B. When content viewer 0101 makes a request for annotation content of format B, while the annotation content repository 0107 only contains annotation content of format A, the application server 0105 retrieves the annotation content of format A from the annotation content repository 0107, invokes the annotation content conversion library 0121, and passes the annotation content of format A to the conversion library. The annotation content conversion library 0121 then converts the annotation content from format A to format B, and returns the result to the application server 0105 which then delivers the converted annotation content to the requesting content viewer 0101. The content conversion library 0121 integrated into the content server 0106 works the same way. When a content viewer 0101 making a request for annotation content to the content server 0106, the content server 0106 retrieves the annotation content from the annotation content repository 0107, invokes the annotation content conversion library 0121 to convert the annotation content from format A to format B, and then deliver the converted annotation content to the requesting content viewer 0101.

Although the integrations of the annotation content conversion library 0121 require the modification of the application server 0105 or the content server 0106 or both, one benefit of such a system is that it allows automated and on-demand annotation content conversion, thus the co-existence of different content viewers in the same content management system. For example, content viewer 0101 is one content viewer, while content viewer 0102 another content viewer licensed from different content viewer vendors. The formats of the annotation contents generated from the two content viewers are not compatible with each other. With the implementation and integration of the annotation content conversion library 0121, annotation objects created from viewer 0101 can be viewed immediately from content viewer 0102, even though the two content viewers support different annotation content formats.

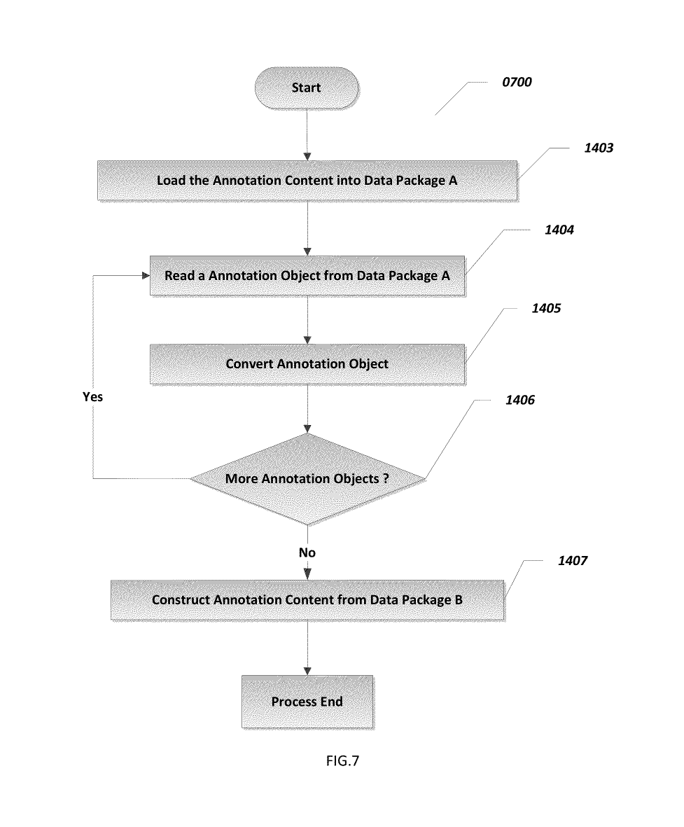

FIG. 7 is a flowchart illustrating the conversion process of the annotation content conversion library 0121. This flowchart is a stripped down version of the flowchart shown in FIG. 6 since the annotation content conversion library 0121 is only responsible for converting single annotation content 0901 of a specified format to the annotation content 0902 of another specified format. This process represents the building block of this invention. This process can be used directly for building in-memory, on-demand annotation content conversion utilities and libraries. With some extra belts and whistles, this process can be used for building batch processing of annotation contents across the annotation content repository as described in FIG. 6.

FIG. 2B illustrates another exemplary content management system where one or more annotation servers 0108 are responsible for handling annotation content requests from the client side and delivering the requested annotation contents to the requesting client. In this content management system, annotation content conversion library 0123 implemented in accordance with one embodiment of this invention is integrated into the annotation server 0108. This content management system works almost the same as that described in FIG. 2A with the only exception being that the annotation server 0108, rather than the application server 0105 or the content server 0106, is responsible for annotation contents delivery. The execution process of the annotation content conversion library 0123 is exactly the same as that of annotation content conversion library 0121 described in FIG. 7.

FIG. 2C illustrates the same exemplary enterprise content management system where one or more application servers 0105 and one or more content servers 0106 are responsible for handling annotation content requests from the client side, retrieving the requested annotation content from the annotation content repository 0107 before delivering the requested annotation contents to the request content viewer 0101, and saving annotation contents uploaded from the content viewer 0101 to the annotation content repository 0107. In this content management system, annotation content conversion library 0124 implemented in accordance with one embodiment of this invention is integrated into the application server 0105, the content server 0106 or both, and annotation contents stored in the annotation content repository 0107 are all in the storage format 0110. When a content viewer 0101 makes an annotation content download request, the content server 0106 retrieves the requested annotation content from the annotation content repository 0107, converts the annotation content from the storage format to the format native to the requesting content viewer 0101, and then delivers the converted content to the content viewer 0101. When a content viewer 0101 makes an annotation content upload request, the content server 0106 handles the request by converting the uploaded annotation content from the native format of the content viewer 0101 to the storage format, and then saves the converted annotation content into the annotation content repository 0107. If the application server 0105 is also responsible for handling annotation content requests from the client side, with the integration of the annotation content conversion library 0124, it works exactly the same as described above for the content server 0106.

With this exemplary content management system, organizations can guarantee that annotation contents of a standard, unified format are stored in the annotation content repository 0107. Having a standard, unified storage format across the annotation content repository 0107 enhances the transparency of annotation content to various components of a content management system. Such transparency facilitates the implementation of content management tools that search the contents of annotations. Without a standard, unified format for storing annotation contents, annotation contents of different formats created by different content viewers would generally by inaccessible to most of the components of a content management system.

Annotation content conversion libraries 0121 and 0123 only support conversion of annotation content from the repository for display on the client viewers. In contrast, the annotation content conversion library 0124 not only converts annotation content from the repository 0107 for display on the client viewers 0101-010N, it also converts annotation content created on the client viewers 0101-010N to the standard, unified storage format for storage in the repository 0107. For the download of annotation contents from the annotation content repository 0107 to content viewer 0101, conversion is performed from the storage format to the particular format native to any of the content viewers 0101-010N included in the content management system, while for the upload of annotation contents from content any one of the content viewers 0101-010N included in the content management system to the annotation content repository 0107, conversion is performed from the format native to the particular content viewer 0101-010N to the storage format.

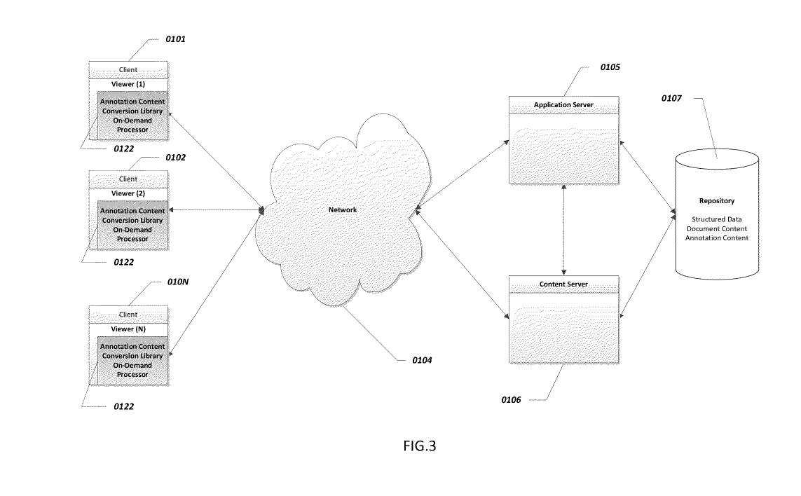

FIG. 3 illustrates another exemplary content management system implemented in accordance with one embodiment of this invention. In this embodiment, an indeterminate number of content viewers 0101 through 010N are deployed and connected to the system, and annotation content conversion library 0122 is integrated into one or more of these content viewers 0101 through 010N. The different content viewers 0101 through 010N may also have different native annotation content formats as between each other. And the application server 0105 saves annotation contents native to the requesting content viewer directly to the annotation content repository 0107 without any modifications. Also the application server 0105 delivers annotation contents directly out of the annotation content repository 0107 without any modifications. Without the integration of annotation content conversion library 0122, content viewer 0101 is able to display annotation contents if they are generated from viewers having the same annotation content format. However, if annotation contents are generated from a content viewer with a different, incompatible annotation content format, the annotation contents will not be accurately displayed because of the incompatibility of the annotation formats.

According to one embodiment of this invention, the annotation content conversion library 0122 is able to detect the annotation format and convert the annotation to the format native to the content viewer. If annotation content conversion library 0122 is integrated into the content viewer 0101, the content viewer is able to display all annotation contents of all formats supported by the annotation content conversion library 0122.

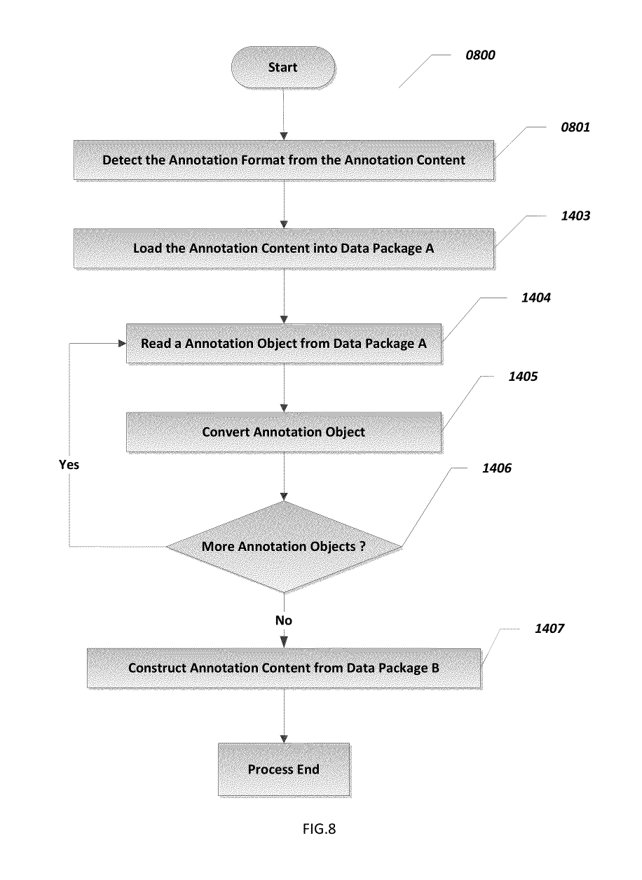

FIG. 8 illustrates the execution sequence of annotation content conversion library 0122. Content viewer 0101 requests annotation content for the document displayed in the viewer from the application server 0105. The application server 0105 retrieves the annotation content associated with the document, regardless of it format, and returns the annotation content back to the content viewer 0101. After receiving successful response from the application server, the content viewer invokes the annotation content conversion library 0122 and passes the received annotation content to it. The annotation content conversion library 0122 detects the annotation format from the annotation content, and then executes the annotation content conversion process from whatever the format received to the format native to the content viewer 0101, and then passes the converted annotation content back to the content viewer 0101 for display. One benefit of this system is that content viewer vendors can integrate the annotation content conversion library 0122 into the content viewer and make it able to display annotation contents created by other content viewers without modifying the server side infrastructure.

FIG. 8 shows the flowchart of the conversion process implemented at the annotation content conversion library 0122. This flowchart is generally the same as the flowchart described in FIG. 7 with the only exception being that step 0801 is added to the beginning of the process. This is the only difference between annotation content conversion library 0122 and annotation content conversion library 0121. At step 0801, the library detects the actual format of the input annotation content 0401 before loading the annotation content into a data package.

The technique used in the exemplary content management system described above is applicable to another content management system where content viewers 0101 through 010N are all thin clients built on top of HTML and JavaScript, and they rely on one or more document rendering servers to render various types of documents into displayable images for the thin client viewer to display. In such system, if some legacy annotation contents generated by some third party content viewers and stored in the content management system 0107 need to be rendered on top of the document images before delivering them to the content viewer 0101 through 010N, the annotation content conversion library 0122 can be integrated into the rendering server to automatically detect the annotation contents retrieved from the annotation content repository 0107, and convert the annotation contents from their original format to the format native to the rendering server. This way, end users don't lose any annotation data when they display document from within thin client content viewers.

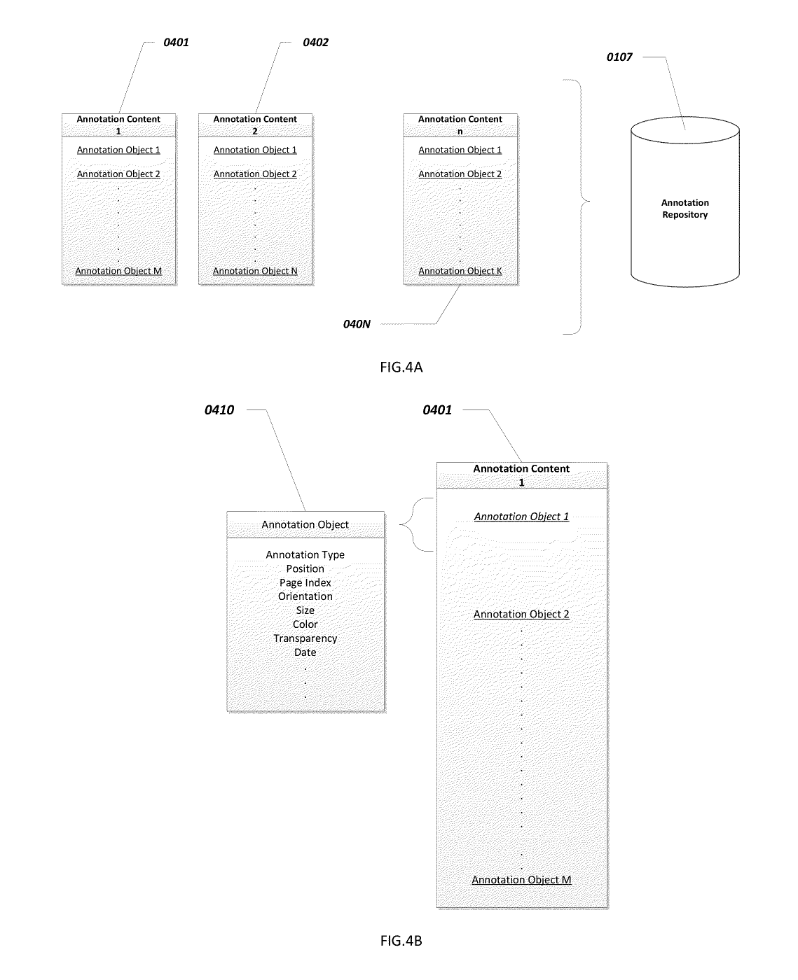

FIG. 4A shows how annotation contents are stored in the annotation content repository 0107. Annotation content 0401 represents a single annotation content comprised of one or more annotation objects, Annotation Object 1 through Annotation Object M. The annotation content repository 0107 may contain multiple annotation contents such as annotation content 0401 through annotation content 040N as shown in FIG. 4A. Each annotation content is associated with a document that it was created for. Each document may have an unlimited number of annotation contents associated with it. A single annotation content can be a single content file for a user in the content management system. If 5 users annotated the same document, there might be 5 annotation content files associated with the document. For a content management system with a large number of documents stored in the content repository, there can be a very large number of annotation contents created and associated with the documents. From the data storage perspective, a single annotation content can also be a database row in the annotation content repository 0107. However, from the data transfer perspective, annotation content might not be the same. First of all, depending on requirements and the implementations, the application server 0105 or the content server 0106 may or may not deliver annotation content as it's stored in the annotation content repository 0107. The application server 0105 or the content server 0106 may combine two or more annotation contents stored in the annotation content repository 0107 into single annotation content before delivering it to the content viewer 0101. For example, the content viewer 0101 may request all annotations from all users for a specific document. Second, annotation contents stored in the annotation content repository 0107 might not be in a deliverable state. If annotation contents are stored in the annotation content repository 0107 as files, the application server 0105 or the content server 0106 may retrieve the files from the annotation content repository 0107 and deliver the content of the files directly to the calling client as requested. However, a database row is not directly deliverable to the requesting clients. If annotation contents are stored in the annotation content repository 0107 as rows of a database table, single annotation content usually is retrieved from the annotation content repository 0107 as an annotation property object, and then the annotation property object is serialized or marshaled into binary stream or text stream before the annotation content can be delivered across the network to the requesting clients. The content server 0106, application server 0105 or whatever server is responsible for delivering annotation contents to the clients where annotation contents are used natively for display purpose must convert annotation content from the storage format to the appropriate data transfer format.

FIG. 4B shows an exemplary internal data structure of an annotation object 0410: Annotation content 0401 is comprised of multiple annotation objects such as Annotation Object 1, Annotation Object 2 through Annotation Object M. Each annotation object is an instance of an annotation type that a particular content viewer defines. Each annotation type is comprised of a set of annotation attributes. Some attributes are directly related to visual aspect of an annotation object displayed inside a content viewer, such as position, size, color, shape and transparency etc. Some attributes, such as the index of the document page on which the annotation object is applied, may not be directly related to visual aspect of the annotation object. Due to lack of any broadly-disseminated standards, annotation content 0401 is usually proprietary to the content viewer from which the annotation content is created. The differences between annotation contents of differing proprietary formats are specifically manifested in the format of the annotation objects as well as the unit systems, schemes and specifications for the values of various annotation attributes. For example, the value of the type of the annotation object for a rectangle annotation can be called “RECTANGLE” by one content viewer, and “rect” by another content viewer. One content viewer may use X, Y, WIDTH and HEIGHT four attributes to specify the location and size of a rectangle annotation object, while another content viewer uses top, left, bottom, right four attributes to specify the location and size of a rectangle annotation object. As another example, one content viewer may use left to right and top to bottom coordinate system to specify the location of an annotation object in the viewer, while another content viewer uses left to right and bottom to top coordinate system to specify the location of an annotation object in the viewer. Further, one content viewer may use “255, 0, 0” to denote the RGB color of an annotation object, while some content viewer may use “FF0000” to denote the RGB color, and some other viewer may simply use an integer. There are many differences in the format and internal data structure between two annotation contents created from two different content viewers. Without conversions, one content viewer is not able to accurately render the annotation contents created by another type of content viewer.

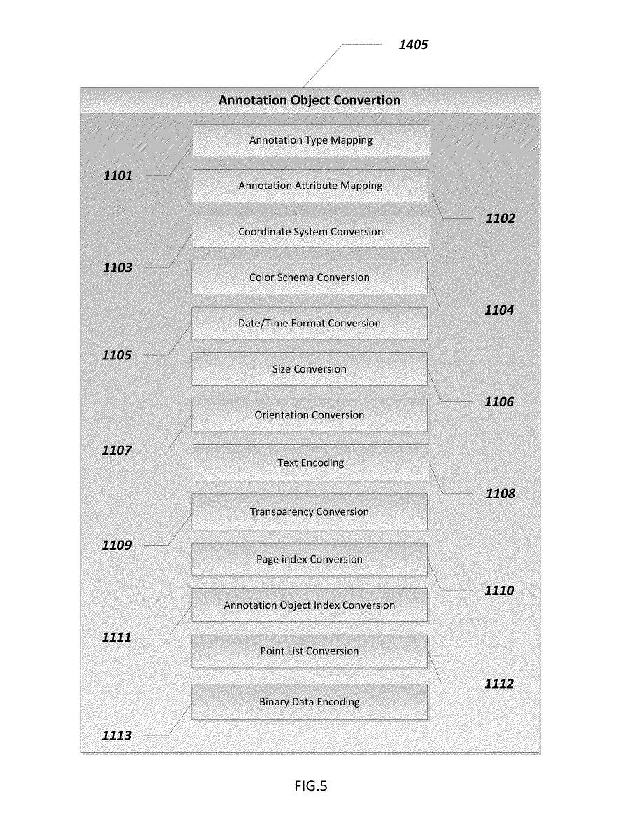

FIG. 5 shows schematically one approach to the conversion of values between different unit systems, schemes, and specifications for various annotation attributes. In all embodiments of this invention, Annotation Object Conversion 1405 is the core of the annotation content conversions. Following list corresponds to the specific differences between the two different formats of annotation content and they are each implemented to convert annotation content with minimal data loss:
1) Annotation Type Mapping 1101. Each annotation format defines a set of annotation types. For some common annotation types, there is one-to-one correspondence between two annotation formats. For example, lines, arrows, polyline, polygon, freehand etc. However, some annotation format defines an annotation type that the target annotation format does not, when converting annotation object from the source to the target, the source annotation object type must be mapped to an annotation object that the target format defines in order to avoid data loss. For example , in one embodiment of this invention, a source annotation format defines an Arc type which is a circle with a portion of it not drawn on the screen, while the target annotation format does not support the Arc type. When converting an annotation object of the Arc type from the source format to the target format, the Arc type in the source format can be mapped to the Freehand type in the target. Another embodiment where annotation type mapping can be used is when the source format defines an annotation type with the drawing mechanism proprietary to the content viewer vendor and unknown to the rest of the world. When converting an annotation object of this type, the annotation type may be mapped to an annotation type defined in the target annotation format. An example is the Ellipse annotation type in which the drawing mechanism is proprietary to the content viewer vendor who invented the annotation format, while the target format does not define the same annotation type, but only defines the Oval annotation type which is a close match to an ellipse shape. When converting an annotation object of the Ellipse type from the source annotation format to the target format, the Ellipse type from the source can be mapped to the Oval type in the target in order to minimize or avoid data loss. An annotation type with unknown drawing mechanism from the source form at can be mapped to the closest annotation type with a well known drawing mechanism in the target format.
2) Annotation Attribute Mapping 1102. Each annotation format defines a set of attributes for a specific type of annotation object. Since the annotation format is proprietary to the vendor of a content viewer that generates the annotation objects and the annotation content that contains the annotation objects, the annotation attributes are generally not compatible from annotation format to annotation format. For example, annotation format A defines “X1” and “Y1” attributes to indicate the horizontal and vertical coordinates of one end of the annotation object of the line type, and “X2” and “Y2” attributes for the horizontal and vertical coordinates of the other end of the annotation object of the line type. While, annotation format B may define a “Point” XML element for single coordinate position with “x” and “y” attributes indicating the horizontal and vertical coordinate values of both ends of the annotation object of the line type. A mapping between these two annotation attribute definitions facilitates converting annotation objects from one format to another.
3) Coordinate System Conversion 1103. Generally, each content viewer uses its own coordinate system to lay annotation objects on top of the document displayed in the viewer screen. Some viewer uses the left to right and top to bottom coordinate system with horizontal coordinate starting from the left of the screen and increasing going rightward, and with vertical coordinate start from the top of the screen and increasing going downward. This is the common coordinate system. However, some content viewers adopt the left to right, bottom to top coordinate system with the vertical coordinate starting from the bottom of the document and increasing going upwards. The coordinate values contained in the annotation contents 0401 and each annotation object 0410 are based on the coordinate system. Coordinate values can be converted from the source coordinate system to the target coordinate system when converting annotation contents from annotation format A to another format B. This data conversion, assures that the location of an annotation object relative to the underlying document will be preserved after annotation content conversions. Without this conversion, annotation objects may show up in completely different locations as between differing annotation formats.
4) Color Schema Conversion 1104. Each annotation format has its own coding for color information for annotation objects 0410 in the annotation content 0401. Some content viewers use comma-separated RGB decimals to indicate the color of an annotation object 0410, such as “255, 0, 0” for red color. Some content viewer uses an integer value to indicate the color, for example 255 for red color. Some other viewers use a hexadecimal string to indicate the color of an annotation object 0410, for example #FF0000. Conversion of these color codes facilitate persistence of original color schemes when converting annotation content 0401 from one format to another in this embodiment.
5) Date/Time Format Conversion 1105. Each annotation format has its own way to persist the Date/Time information for annotation objects 0410 in the annotation content 0401. Date/Time values are used in the annotation content 0401 to indicate when the annotation object is created or modified, or some other time sensitive data. Some content viewers use a formatted string to persist the date/time value, such as “18 Jun 2012, 15:53:45 EDT”. Some content viewers use another format, such as “2012-06-18T15:53:45”. Still other content viewers use an integer to persist the date/time value. Date/time conversion is required when converting annotation contents 0401 from one format to another.
6) Size Value Conversion 1106. Each annotation format has its own way to persist the size values in the annotation content 0401. Some annotation types have a size attribute to indicate the dimension of the attribute. For example line width indicates the dimension of a line. Another example is the font size of a textual annotation object. The way size values are interpreted differs between different content viewers. Some content viewers use pixels to indicate the line width, with line width 5 meaning the line is 5 pixels wide. Some other content viewers use point as the unit of line width and font size. Conversions of the size values from one size unit to another persists the actual original size when converting annotation content 0401.
7) Orientation Value Conversion 1107. Each annotation format has its own way to persist the information about the orientation of an annotation object 0410 in the annotation content 0401. Text can be displayed in different orientations within the viewer. For example, it can be horizontal, vertical, reversed, or even with some angles along a line. When converting annotation content 0401, conversion of the orientation information of an annotation object 0410 can be performed so that the target annotation content displays each annotation object with the desired orientation.
8) Text Encoding 1108. If an annotation is textual, each annotation format may use different encodings for the text. Although UTF-8 text encoding is very common in the industry, there are other encoding schemes widely used in popular platforms, for example UTF-16, UTF-32 etc. When converting annotation content 0401, the difference between text encodings for each annotation format can also be taken into considerations, in order to allow text annotations, even texts for multi-byte languages get displayed correctly after conversion.
9) Transparency Value Conversion 1109. Each annotation format has its own way to persist the information of the transparency of an annotation object 0410 in the annotation content 0401. Different format may use different attribute to indicate the transparency of an annotation object 0410. For example, some format uses a “transparent” annotation attribute that is assigned the value of either true or false. Some format uses the “opaque” annotation attribute with the value of “transparent” for indication. Some other formats use an “opacity” annotation attribute with a continuous float value from 0 to 1 for indication. When converting annotation contents 0401 from one format to another, annotation attribute name and value translation may be taken into consideration.
10) Page Index Conversion 1110. Each annotation format has its own way to persist the page index for an annotation object 0410 in the annotation content 0401. Each annotation object 0410 in annotation content 0401 must have an attribute to indicate which page the annotation object 0410 resides on. Without the page index value, the content viewer does not know which page of the document to overlay the annotation object on. The schema for page index might be different from content viewer to content viewer. Some content viewers use 0-based page index schema while other content viewers use 1-based page index schema. When converting annotation objects 0410, the difference in page index schema can be taken into consideration in order to avoid an annotation object 0410 created from one content viewer on a specific document page showing up on another page when viewed on another content viewer after annotation content conversion.
11) Annotation Object Index Conversion 1111. Each annotation format has its own way to persist the annotation object index for an annotation object 0410 in the annotation content 0401. Annotation object index is used to indicate the z-order of annotation objects on the same page. When two or more annotation objects 0410 overlap with each other on the same page, the annotation object 0401 with a relatively higher value in the annotation object index appears on top of any annotation objects 0401 with relatively lower values in the annotation object index. Again, the schema for annotation object index might be different from content viewer to content viewer. Some content viewers use 0-based indexing schema while other content viewers use 1-based indexing schema. When converting annotation object 0410, the difference in the schema for annotation object index can be taken into considerations.
12) Point List Conversion 1112. Each annotation format has its own way to encode and persist a point list for an annotation object 0410 in the annotation content 0401. For some multi-point annotation objects 0410, for example polygons, polylines and freehand etc, some content viewers explicitly persists a list of points with each point containing the X and Y coordinate values in the annotation content 0401, while some other content viewers encode the point list in the annotation content 0401 to save some space. Some content viewers use integer values for each coordinate point, while other content viewer uses float values for each point. These differences may be taken into account to correctly convert multi-point annotation objects 0410 from one format to another.
13) Binary Data Encoding 1113. Each annotation format has its own way to encode and persist binary data for an annotation object 0410 in the annotation content 0401. Some content viewers use binary data to create image “rubber stamps”, such as the content of a company logo. If the annotation content is text based, binary data can be encoded into text as the content of the annotation object of image rubber stamp type. Base64 encoding is widely adopted in the industry for binary data encoding. There are other binary encoding schemes available, and each content viewer may use different encoding algorithms for binary data encoding. Conversion between different binary encoding schemes can be implemented to convert “rubber stamp” type annotation objects in the Annotation Object Conversion 1405.

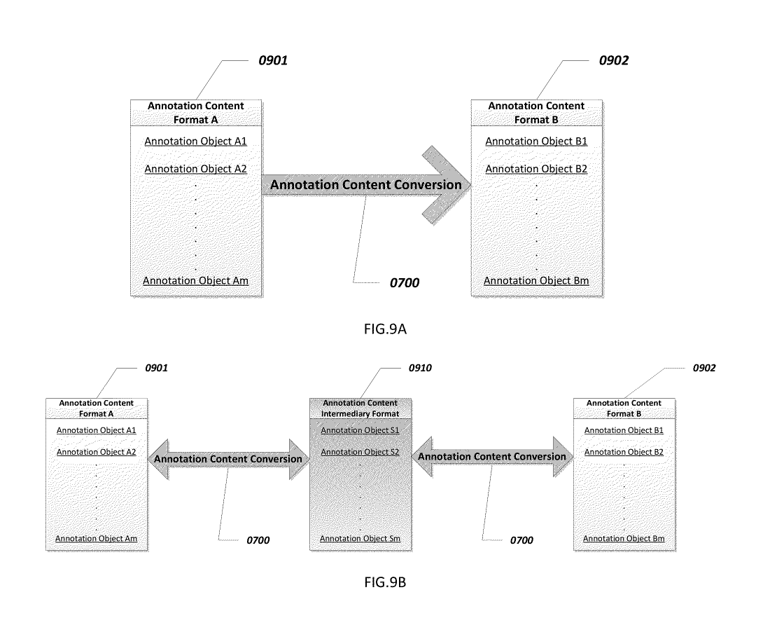

FIG. 9A illustrates a direct conversion method that converts annotation contents directly from format A to format B. In the figure, annotation content 0901 is in format A and annotation content 0902 is in format B. Annotation Content Conversion 0700 represents the actual conversion procedure. Direct conversion is simple to implement and uses less computer memory to execute. It's suited for environments where there are only two annotation formats involved in the content management system. But direct conversion requires the implementation of the Annotation Content Conversion 0700 be aware of both the source format and the target format, thus tightly couples the types of the data package for both formats. Such tight coupling of the source annotation format with the target annotation format leaves very small room for code sharing and reusability. If it were also desired that Annotation Content Conversion 0700 also support a third format C, a lot of implementation code would need to be duplicated for conversion from format A to C, B to C etc.

FIG. 9B illustrates a two-step annotation content conversion method that converts the source annotation content 0901 in format A to annotation content 0910 in format S, and then converts annotation content in format S to the target annotation content 0902 in format B. Format S is an intermediary annotation content format preferably neutral to all content viewers involved in the conversions. Annotation Content Conversion 0700 represents the actual conversion procedure, which takes place in two steps. One of the benefits of this method of annotation content conversion is that at the implementation level each step of the Annotation Content Conversion process 0700 need only address the conversion between S and one other format. In contrast, with the direct conversion approach, Annotation Content Conversion 0700 must be aware of both the source format and the target format, which tightly couples both formats and the associated data structures or classes with the actual implementations. So is the implementation of Annotation Object Conversion 1405. Conversion from format A to format B, and conversion from format B to format A becomes separate routines. Code reuse becomes less likely. When support of format C is added into the annotation contents conversion tool 0120, or annotation conversion library 0121, a lot of code might be duplicated in the implementation of Annotation Content Conversion 0700 and Annotation Object Conversion 1405 as a result. Code duplications make code maintenance difficult later on. The two-step annotation content conversion method resolves this issue by modularizing the implementations of annotation conversions. With the introduction of an intermediary annotation format S and two interfaces, it is possible to modularize the annotation content conversion implementations by the boundaries of annotation formats. For each native format, people only need to implement the conversion interface from the native format to the intermedary format and the conversion interface from the intermediary format to the native format. Owing to the fact that conversion implementations are modularized by the boundaries between native format, code duplication can be significantly reduced.

As an example of the two-step annotation content conversion, one can introduce the following two interfaces:
DataPackage_IntermediaryFormat Convert (Stream)
Stream Convert (DataPackage_IntermediaryFormat)

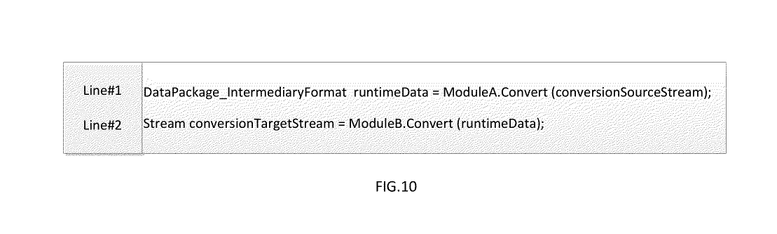

With the first interface referred to as the conversion input interface, which converts annotation content of a content viewer native format to the intermediary format, and the second interface referred to as the conversion output interface which converts annotation content of the intermediary format to a content viewer native format. DataPackage_IntermediaryFormat is the name of a class representing the data package for annotation content of the intermediary format, and Stream is the name of a class representing the annotation content container for annotation content of a content viewer native format. The conversion input interface takes an input annotation content stream of the format of the conversion source, converts the input stream into annotation content of the intermediary format and returns the object of the predefined class DataPackage_IntermediaryFormat. The conversion output interface takes an object of the property class DataPackage_IntermediaryFormat, and converts the input into annotation content of a content viewer native format and returns a data stream containing the converted annotation content. For each native annotation format, it is only needed to implement these two interface methods. Conversion implementations for native format A do not need to have knowledge of any other native formats. Conversion implementations become modular and reusable. For actual annotation content conversions from native format A to native format B, the glue code become very simple as shown in FIG. 10, where ModuleA represents the implementation of the conversion interface for format A, and ModuleB represents the implementation of the conversion interface for format B.

Internally, at the implementation of the conversion input interface, the input stream is deserialized or unmarshalled into a property class for annotation content of the input format before the conversion from the native format to the intermediary format is performed. Deserialization or unmarshalling makes the input annotation content randomly accessible in memory, which allows the result of the first conversion method to be used by other utilities, for example the utility that implements the second conversion interface method. Internally, at the implementation of the conversion output interface, the converted annotation content must be serialized or marshaled into the stream object after the conversion from the intermediary format to the native format is performed. Serialization or marshalling prepares the output annotation content processed by other utilities, for example the utility that implements the first conversion interface method. With only two lines of glue code, annotation content of format A contained in a data stream is converted into a data stream containing the annotation content of format B. Similar glue code can be written for annotation conversion from format B to format A. The glue code will not need to be changed if support for format C is added into the annotation conversion library, nor does the implementation of the interfaces for format A and format B.

This is just an exemplary description of the conversion interfaces. Using a hypothetical class DataPackage_IntermediaryFormat as the data package for annotation content of the intermediary format, and Stream class as the content container for native formats. In another embodiment, Stream class can also be used as the data package for annotation content of the intermediary format, and a File class as the content container for native formats. These embodiments all exhibit polymorphism between the containers for annotation content of the source format and the target format. In addition to a stream class, a file class, a string, byte array or a predefined data structure may also serve as the content container.

One important characteristics of the two-step conversion method is that it encompasses the direct conversion method described in FIG. 9A. The direct conversion method is simply a special use case of the two-step conversion method. Using the exemplary conversion interfaces described above, direct conversion from format A to format B can be achieved by simply implementing one of the interface methods. If you designates format B as the intermediary format, implementing the conversion input interface for format A will be able to achieve annotation content conversion from format A to format B. If you don't care about conversions from format B to format A, there is no need to implement the conversion output interface.

The two-step conversion method requires the introduction of an intermediary annotation format that encompasses all essential annotation attributes from all annotation formats supported by the Annotation Content Conversion 0700. The criteria for deciding which annotation attributes are essential is determined by looking at whether the omission of an annotation attribute will affect the visual representation of the annotation object in the target content viewer. In principle, if the answer is no, then the attribute can be omitted without consequence; it is not essential. However if the answer is yes, omission of the attribute will result in lost or inaccurately displayed annotation content. I practice, due to extensive and complicated differences between various annotation formats, dropping of some of the less desired visual representation details might be permissible. In this case, user feedback may provide criteria for deciding a level of satisfactory inclusion of annotation attributes in the intermediary format.

The intermediary format can be any existing format that the annotation conversion tools & libraries support. If the tools & libraries support format A, B and C, the intermediary format can be any of them. The intermediary format can be an annotation format of new invention also, as long as it is designed to prevent data loss during conversions.

The two-step conversion method is applicable to conversions among more than two objects of any content, for example but not limited to file formats, data structures, data objects, classes, as long as all the objects in question can be categorized and abstracted into an intermediary object without losing of important data.

Finally, as shown in FIG. 2C, the two-step conversion method can be applied to a content management system where the intermediary format is used as the storage format. A storage format neutral to all content viewers makes the searching into annotation contents easier to implement. When content viewer 0101 requests to upload annotation content to the content management system, the content server 0106 takes the uploaded annotation content as a stream, invokes the annotation conversion interface for the native format for the content viewer 0101 to convert the data stream from the format native to the content viewer 0101 to the storage format, and then saves the converted annotation content to the annotation content repository 0107. When content viewer 0101 requests to download annotation content, the content server 0106 retrieves the annotation content from the annotation content repository, invokes the annotation conversion interface for the native format for the content viewer 0101 to convert the annotation format from the storage format to the format that the content viewer 0101 requested, and then delivers the stream of converted annotation content to the content viewer 0101. With the implementation and integration of annotation content conversion at the server side, there is no need to change the content viewer 0101 in order to deal with annotation contents stored in the annotation content repository 0107 in the storage format which is different from the native format to the content viewer. The concept of the storage format can be applied to content viewer 0101 too. With the implementation and integration of annotation content conversion at the client side, the content viewer 0101 receives annotation contents of the storage format from the content server 0106, invokes the annotation content conversion code to convert the received annotation content from the storage format to the native format, and then passes the converted annotation content to the annotation display apparatus for display. Similarly, when a user creates annotations from within the content viewer 0101 and saves the newly created annotations to the annotation content repository, the content viewer 0101 collects the annotation content in the native format from the annotation display apparatus, invokes the annotation content conversion code to convert the annotation content from the native format to the storage format, and then passes the converted annotation content to the data transfer apparatus to upload the annotation content to the content server 0106 for the creation of a new annotation content in the annotation content repository 0107. With the implementation and integration of annotation content conversion at the client side, there will be no need to make code changes at the server side to deal with annotation contents stored in the annotation content repository 0107 in a storage format that is different from the native format of the content viewer.

Thus, methods and apparatus of annotation content conversions have been described. Particular embodiments described herein are illustrative only and should not limit the present invention hereby. The claims and their full scope of equivalents define the invention.

What is claimed is:

1. A method for annotation content conversion comprising:
Providing an intermediary annotation content format that may or may not be content viewer neutral;
And providing a conversion input interface for converting annotation content from an arbitrary annotation format to said intermediary format;
And providing a conversion output interface for converting annotation content from said intermediary format to an arbitrary annotation format.

2. The method according to claim 1 comprising selecting an annotation content container to directly accommodate, or an identifier to uniquely identify single annotation content irrespectively to the format of the annotation content.

3. The method according to claim 2 comprising providing a data package for temporary containment of collection of annotation attributes of said intermediary format.

4. The method according to claim 3 comprising providing means for parsing and deserializing annotation content from said annotation content container to said annotation data package.

5. The method according to claim 3 comprising providing means for serializing annotation content from said annotation data package into said annotation content container.

6. The method according to claim 3 wherein said conversion input interface takes said annotation content container as the input of the annotation content conversion, outputs annotation content of said intermediary format in the form of said annotation data package.

7. The method according to claim 4 comprising providing implementations of said conversion input interface respectively for annotation formats of the conversion source and the conversion target, wherein said deserialization means is invoked to deserialize the input annotation content to said annotation data package.

8. The method according to claim 3 wherein said conversion output interface takes annotation content of said intermediary format as the input of the annotation conversion in the form of said annotation data package, outputs said annotation content container as the output of the conversion.

9. The method according to claim 5 comprising providing implementations of said conversion output interface respectively for annotation format of conversion source and conversion target, wherein said serialization means is invoked to serialize the converted annotation content into said annotation content container.

10. The method according to claim 3 comprising providing one or more controller classes, routines or lines of code that invokes the implementation of said conversion input interface for a specified annotation conversion source format by passing in annotation content of the conversion source format, therefore obtaining the annotation content of said intermediary format as the result of the invocation of the implementation of said conversion input interface, then optionally invokes the implementation of said conversion output interface for another annotation format as the conversion target format by passing in annotation content of said intermediary format, therefore obtaining the annotation content of the conversion target format as the result of the invocation of the implementation of said conversion output interface for the conversion target format.

11. The method according to claim 3 comprising:
Selecting the conversion target format as the intermediary annotation format;
And providing one or more controller classes, routines or lines of code that invokes the implementation of said conversion input interface for a specified annotation conversion source format by passing in annotation content of the conversion source format, therefore obtaining the annotation content of the conversion target format as the result of the invocation of the implementation of said conversion input interface.

12. The method according to claim 3 comprising:
Select the conversion source format as the intermediary annotation format;
And providing one or more controller classes, routines or lines of code that invokes the implementation of said conversion output interface for a specified conversion target format, therefore obtaining the annotation content of the conversion target format as the result of the invocation of the implementation of said conversion output interface for the conversion target format.

13. A method for persisting annotation contents in and retrieving annotation contents from an annotation content repository comprising:
Providing an annotation content format as the annotation content storage format with which all annotation contents are stored in an annotation content repository;
Providing data input conversion means for converting annotation content from a format native to the client to said storage format before annotation contents are saved into the annotation content repository;
Providing data output conversion means for converting annotation content from said storage format to a format native to the client before annotation contents are delivered to the client requesting the specified annotation contents.

14. The method according to claim 13 comprising:
Providing means for receiving annotation contents directly or indirectly upon requests from clients;
Providing means for saving annotation contents of said storage format to the annotation content repository, with said data input conversion means executed after the receiving of annotation content from the requesting clients and before the execution of said annotation content saving means;
Providing means for retrieving annotation contents of said storage format from said annotation content repository upon requests directly or indirectly from clients;
Providing means for delivering annotation contents directly or indirectly to clients, with said data output conversion means executed after the retrieval of annotation content from the annotation content repository, and before the delivery of the converted annotation content to a requesting client.

15. The method according to claim 14 comprising selecting an existing annotation format among all distinct native annotation formats involved in annotation content conversions, as the annotation content storage format with which all annotation contents are stored in an annotation content repository.

16. The method according to claim 14 comprising:
Providing means for converting annotation content at the client side including but not limited to from within a content viewer from said storage format to the format native to the client after receiving annotation content from the server side but prior the display of the annotation content;
And providing means for converting annotation content at the client side including but not limited to from within a content viewer from the format native to the client to said storage format after user creating annotations from within the client but prior sending the converted annotation content to the server side for storage in an annotation content repository.

17. A computer system for annotation content conversions comprising:
One or more executables to be executed by human interactively or by computer programs automatically for converting all annotation contents stored in an annotation content repository at once from a specified format to annotation contents of another specified format.

18. The computer system according to claim 17 wherein said executables comprising:
Means for connecting to an annotation content repository;
And means for querying said annotation content repository for a collection of identifiers each identifying an annotation content of a specified format;
And means for retrieving annotation content by said annotation content identifiers;
And means for converting annotation content from a specified format to another specified format;
And means for saving the converted annotation content to said annotation content repository;
And means for establish relationships between annotation content and the associated document so that newly created annotation content is accessible from the associated document.

19. The computer system according to claim 18 wherein said annotation content conversion means comprising:
Means for mapping a specific annotation type defined in one annotation format to another specified annotation type defined in another annotation format;
And means for mapping a named annotation attribute defined in one annotation format to a named annotation attribute defined in another annotation format;
And means for converting values between different unit systems, schemes, and specifications for various annotation attributes including but not limited to coordinates, color specifications, Date/Time specifications, size, orientation specifications, transparency specifications, page index specifications, annotation object index specifications, point list encoding schemes, binary data encoding schemes, and text encoding schemes.

20. A computer system for content management comprising:
One or more content display apparatus for displaying document content and associated annotation contents to end users;
And an annotation content repository wherein all annotation contents are stored separately from the document contents that said annotation contents are associated with, wherein part of or all said annotation contents are in different format from that of said content display apparatus is able to recognize and display natively;
And means for retrieving annotation content, upon request from clients including but not limited to said content display apparatus, from said annotation content repository;
And means for converting on the fly annotation contents from a specific annotation content format to another annotation content format;
And means for delivering annotation content to the requesting clients including but not limited to said content display apparatus.

21. The computer system according to claim 20 comprising means for handling annotation content requests from said content display apparatus by invoking said annotation retrieval means to retrieve requested annotation contents, then invoking said annotation content conversion means to convert annotation content from one annotation content format to another, and then invoking said annotation content delivery means to deliver the converted annotation content to said content display apparatus for the display of the requested annotation content, wherein said annotation content conversion means is only invoked when the format requested by said content display apparatus is different from the format retrieved from said annotation content repository.

22. The computer system according to claim 21 wherein content display apparatus comprising:
Means for detecting the format of annotation contents received from said annotation content delivery means;
And means for converting on the fly annotation content from a specific annotation content format to another annotation content format;
And means for handling the response from said annotation content delivery means by receiving annotation content delivered by said annotation content delivery means, and then invoking said annotation content detection means to detect the format of the received annotation content, and then invoking said annotation content conversion means to convert the received annotation content from the detected format to the format of said content display apparatus is able to recognize and display natively, wherein said annotation content conversion means is only invoked when the format detected by said annotation content detection means is different from the format native to said content display apparatus.

23. The computer system according to claim 21 comprising:
Means for receiving annotation contents requested from said content display apparatus;
And means for convert annotation content from a specific annotation content format to another annotation content format;
And means for saving annotation content into said annotation content repository as a new record or replacing an existing record, wherein proper relationship between the new annotation content and the document that the new annotation content is associated to is established so that the new annotation content is accessible via the identifier that identifies the document;
And means for handling annotation content requests from said content display apparatus by invoking said annotation content receiving means to receiving annotation content sent from said content display apparatus, and then invoking said annotation content conversion means to convert the received annotation content from one annotation content format to another, and then invoking said annotation content saving means to save the annotation content, converted or not to said annotation content repository, wherein said annotation content conversion means is only invoked when the format of received annotation content is different from the format that must be saved in said annotation content repository.

24. The computer system according to claim 21 wherein said annotation conversion means comprising:
Means for mapping a specific annotation object type defined in one annotation format to another specified annotation object type defined in another annotation format;
And means for mapping a named annotation attribute defined in one annotation format to a named annotation attribute defined in another annotation format;
And means for converting values between different unit systems, schemes, and specifications for various annotation attributes including but not limited to coordinates, color specifications, Date/Time specifications, size, orientation specifications, transparency specifications, page index specifications, annotation object index specifications, point list encoding schemes, binary data encoding schemes, and text encoding schemes.
